(19) United States
(12) Patent Application Publication
(10) Pub. No.: US 2024/0028244 A1
(43) Pub. Date: Jan. 25, 2024

(54) METHODS OF OPERATING MEMORY SYSTEMS WITH INPUT/OUTPUT EXPANDERS FOR MULTI-CHANNEL STATUS READS, AND ASSOCIATED SYSTEMS AND DEVICES

(71) Applicant: Micron Technology, Inc., Boise, ID (US)

(72) Inventors: Yoav Weinberg, Thornhill (CA); Nicola Pantaleo, Toronto (CA); Leonid Minz, Beer Sheva (IL)

(21) Appl. No.: 17/873,046

(22) Filed: Jul. 25, 2022

(51) Int. Cl. G06F 3/06

(52) U.S. Cl. CPC G06F 3/0653; G06F 3/0679; G06F 3/0611

(57) ABSTRACT

Methods of operating memory systems with input/output expanders for multi-channel status reads (and associated systems and devices) are disclosed herein. In one embodiment, a method comprises receiving, via a controller-side communication channel, a multi-channel status read command at a first interface of an input/output expander. The method further comprises, based at least in part on receiving the multi-channel status read command, (a) transmitting, via a second interface of the input/output expander, a status read command to logical units over each of two or more memory-side channels; (b) receiving, at the second interface, status read data from the logical units over each memory-side channel of the two or more memory-side channels; and (c) transmitting, via the first interface, the status read data onto the controller-side communication channel.

### TECHNICAL FIELD

The present disclosure is related to memory systems, devices, and associated methods. For example, several embodiments of the present disclosure are directed to methods of operating memory systems with input/output (I/O) expanders to obtain status read data from logical units across multiple channels, and to associated systems and devices.

### BACKGROUND

Memory devices are widely used to store information related to various electronic devices such as computers, wireless communication devices, cameras, digital displays, and the like. Memory devices are frequently provided as internal, integrated circuits and/or as part of external removable devices in computers or other electronic devices. There are many different types of memory, including volatile and non-volatile memory. Volatile memory, including static random-access memory (SRAM), dynamic random-access memory (DRAM), and synchronous dynamic random-access memory (SDRAM), among others, may require a source of applied power to maintain its data. Non-volatile memory, by contrast, can retain its stored data even when not externally powered. Non-volatile memory is available in a wide variety of technologies, including flash memory (e.g., NAND and NOR), phase change memory (PCM), ferroelectric random-access memory (FeRAM), resistive random access memory (RRAM), and magnetic random-access memory (MRAM), among others. Improving memory devices, generally, may include increasing memory cell density, increasing performance (e.g., read, write, erase speeds) or otherwise reducing operational latency, increasing reliability, increasing data retention, reducing power consumption, reducing manufacturing costs, or reducing dimensional attributes, among other metrics.

### BRIEF DESCRIPTION OF THE DRAWINGS

The disclosure will be understood more fully from the detailed description given below and from the accompanying drawings of various embodiments of the present disclosure. The components in the drawings are not necessarily to scale. Instead, emphasis is placed on illustrating clearly the principles of the present technology. The drawings should not be taken to limit the disclosure to the specific embodiments, but are for explanation and understanding only.

FIG. 1 is a partially schematic block diagram of a memory system configured in accordance with various embodiments of the present technology.

FIG. 2 is a flow diagram illustrating a method of operating a memory device in accordance with various embodiments of the present technology.

FIG. 3 illustrates several signal diagrams showing the timing of various signals transmitted during the method of FIG. 2, in accordance with various embodiments of the present technology.

FIG. 4 is a partially schematic block diagram of a system that includes a memory device configured in accordance with various embodiments of the present technology.

### DETAILED DESCRIPTION

As discussed in greater detail below, the technology disclosed herein relates to methods of operating memory systems with input/output (I/O) expanders to obtain status read data from logical units across multiple channels, and to associated systems and devices. For example, in one embodiment, a memory controller issues a multi-channel status read command to an I/O expander over a front-end channel. The multi-channel status read command prompts the I/O expander to transmit status read commands to logical units (e.g., memory packages, memory dies) over two or more back-end channels. The logical units return status read data in response to the status read commands, and the I/O expander cycles through the individual back-end channels of the two or more back-end channels to feed the status read data from a corresponding back-end channel to the memory controller over the front-end channel. In this manner, the memory controller can, in response to a single multi-channel status read command, obtain status read data from logical units across multiple back-end channels.

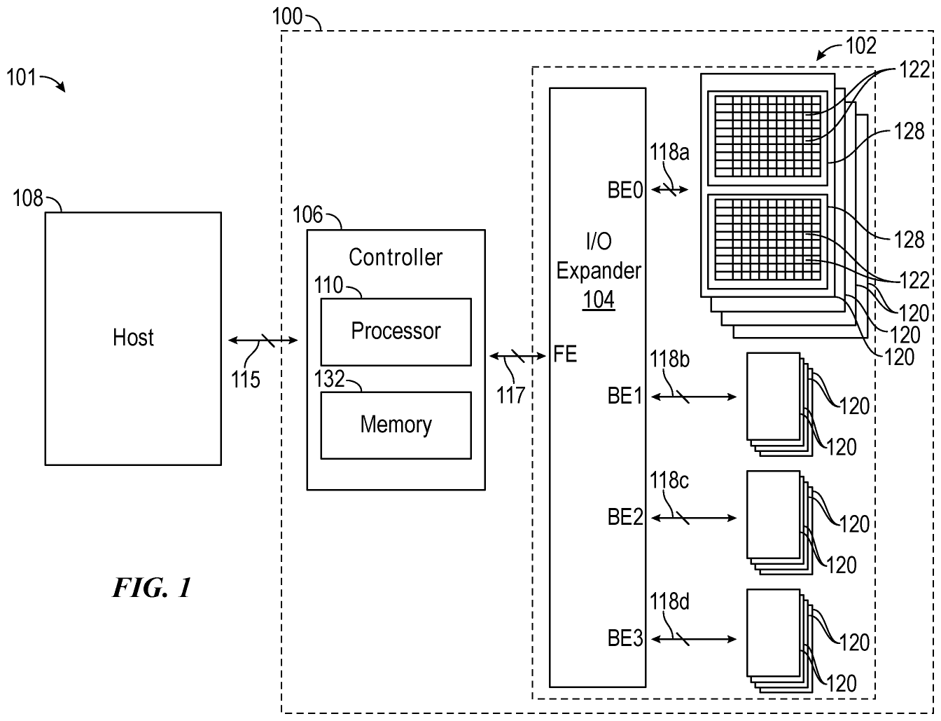

In the illustrated embodiments below, the memory devices are primarily described in the context of devices incorporating NAND-based storage media (e.g., NAND flash). Memory devices configured in accordance with other embodiments of the present technology, however, can include other types of memory devices (e.g., hard disk drives, phase change memory, ferroelectric, etc.) and/or can include main memories that are not NAND-based (e.g., that are NOR-based) or only partially NAND-based. Moreover, memory devices configured in accordance with still other embodiments of the present technology can include volatile memories, such as DRAM and/or SRAM memories. A person skilled in the art will understand that the technology may have additional embodiments and that the technology may be practiced without several of the details of the embodiments described below with reference to FIGS. 1-4.

### A. OVERVIEW

Many memory systems include input/output (I/O) expanders. An I/O expander expands an I/O channel into multiple I/O channels. For example, an I/O expander (a) can be operably coupled to a memory controller at a front end via a front-end I/O channel and (b) can be operably coupled to a plurality of logical units (e.g., memory packages, memory dies) at a back end via two or more back-end I/O channels. When the I/O expander receives a communication from the memory controller via the front-end channel that is intended for one or more of the logical units, the I/O expander can route the first communication to the one or more logical units via corresponding ones of the back-end channels. When the I/O expander receives a communication from a logical unit via a back-end channel that is intended for the memory controller, the I/O expander can route the communication to the memory controller via the front-end channel. In other words, the I/O expander selectively couples the front-end channel to one or more of the back-end channels such that the memory controller can communicate with various logical units via the front-end channel. In this manner, the I/O expander expands the front-end channel into two or more communication channels (represented by the front-end channel in combination with each one of the two or more back-end channels).

To communicate with specific logical units via the I/O expander, the memory controller typically must first instruct the I/O expander to couple the front-end channel to corresponding ones of the back-end channels and then wait for the I/O expander to make the appropriate connections. For example, the memory controller can transmit signals (e.g., chip enable signals CE #) and/or commands (e.g., volume select commands) to the I/O expander to identify the back-end channels to which the I/O expander should couple the front-end channel. In response, the I/O expander can couple the front-end channel to the identified back-end channels such that the memory controller is enabled, via the I/O expander, to transmit communications to or receive communications from the specific logical units. In other words, each time the memory controller wants to communicate with logical units coupled to a different subset of the back-end channels, there is a delay (equivalent to the time required (i) for the memory controller to instruct the I/O expander to couple the front-end channel to the different subset of back-end channels and/or (ii) for the I/O expander to complete the requested connections) before the memory controller is enabled to communicate with the logical units over that subset of back-end channels. Such delays can increase the overhead of the I/O bus, especially in scenarios in which the memory controller transmits or receives a sequence of communications using different combinations of the back-end channels.

One such scenario involves status reads. For example, a memory controller can issue commands (e.g., access commands) to various logical units instructing the logical units to perform operations. Each of the logical units can be operably coupled to the memory controller via an I/O expander and a corresponding one of a plurality of back-end channels. After issuing the commands, the memory controller can issue status read commands to the logical units to determine which of the operations have been completed and on which of the logical units. In response, the logical units can, via the plurality of back-end channels, return status read data (by performing status read operations) to the memory controller that indicate which operations have been completed, which operations are still in progress, and/or which operations have yet to be completed. More specifically, the memory controller obtains status read data from the logical units one back-end channel at a time. In particular, for each back-end channel in the plurality of back-end channels, the memory controller (a) signals the I/O expander to couple the front-end channel to a back-end channel, (b) waits for the I/O expander to couple the front-end channel to the back-end channel, (c) issues status read commands to logical units operably coupled to the back-end channel, and (d) receives status read data from the logical units via the back-end channel and the front-end channel. Thus, a delay (associated with (i) the memory controller instructing the I/O expander to couple the front-end channel to a back-end channel and (ii) the I/O expander completing the requested connections in response) is added to the I/O bus overhead for each different back-end channel that the memory controller uses to obtain status read data from the logical units. In other words, the I/O bus overhead of switching between the different back-end channels to obtain status read data from logical units can be as high as the overhead for issuing status read commands to the logical units.

To address these concerns, the present technology is directed to memory systems and devices in which a single status read command is transmitted to I/O expanders to obtain status read data from logical units across multiple back-end channels. For example, in one embodiment, a memory controller can transmit a single multi-channel status read command to an I/O expander via a front-end channel. The single multi-channel status read command can include only one command (e.g., include only one reserved command ID) or can include a plurality of commands (e.g., include a plurality of reserved command IDs) that are sent to the I/O expander in parallel or in sequence within a timing window. The multi-channel status read command prompts the I/O expander to transmit (e.g., forward, relay, pass, feed, route, redrive, issue) status read commands to logical units over two or more back-end channels. In response to the status read command, the logical units can perform status read operations and return status read data to the I/O expander via the two or more back-end channels. The I/O expander can then cycle through the individual back-end channels of the two or more back-end channels to feed (e.g., forward, relay, pass, route, transmit, redrive) the status read data from a corresponding back-end channel to the controller via the front-end channel. In other words, the present technology facilitates obtaining status read data from logical units across multiple back-end channels in response to a single multi-channel status read command. In this manner, the present technology is expected to reduce the I/O bus overhead involved in obtaining status read data from logical units across multiple back-end channels, such as by eliminating one or more instances of the delay associated with (i) the memory controller instructing the I/O expander to couple the front-end channel to one of the back-end channels and (ii) the I/O expander completing the requested connections in response.

### B. SELECTED EMBODIMENTS OF MEMORY SYSTEMS AND DEVICES WITH I/O EXPANDERS, AND ASSOCIATED METHODS

FIG. 1 is a block diagram of a memory system 101 configured in accordance with several embodiments of the present technology. The memory system 101 includes a memory device 100 operably coupled to a host device 108, such as an upstream central processor (CPU). An example of a memory device 100 is a storage system, such as a solid-state drive (SSD). In some embodiments, the memory device 100 is a hybrid memory/storage sub-system.

As shown, the memory device 100 includes a plurality of logical units 120, a controller 106 (e.g., a processing device), and an I/O expander 104 operably coupling the logical units 120 to the controller 106. The controller 106 operably couples the logical units 120 to the host device 108. In some embodiments, the logical units 120 can be individual memory dies, memory packages, memory planes in a single memory die, a stack of memory dies vertically connected with through-silicon vias (TSVs), or the like. For example, as illustrated in FIG. 1, the logical units 120 can be individual memory dies arranged in a memory package 102. As another example, the logical units 120 can be collocated on a single memory die and/or distributed across multiple memory packages 102.

Each of the logical units 120 includes a plurality of memory cells 122. The memory cells 122 can include, for example, NAND flash and/or other suitable storage elements (e.g., NOR flash, read only memory (ROM), electrically erasable programmable ROM EEPROM, erasable programmable ROM (EPROM), ferroelectric, magnetoresistive, phase change memory, etc.) configured to store data persistently or semi-persistently. In one example, the memory cells 122 are arranged in memory pages that are arranged in memory blocks 128. Continuing with this example, the memory blocks 128 can be arranged in memory planes, and the memory planes can be arranged in respective memory dies. As a specific example, the memory cells 122 can include NAND flash storage elements arranged in a 3D NAND topology, configuration, or architecture. The logical units 120 (or a memory package 102 including the logical units 120) can include other circuit components or memory subsystems (not shown), such as multiplexers, decoders, buffers, read/write drivers, address registers, data out/data in registers, etc., for accessing and/or programming (e.g., writing) the memory cells 122 and other functionality, such as for processing information and/or communicating with the controller 106 via the I/O expander 104.

The controller 106 can be a microcontroller, special purpose logic circuitry (e.g., a field programmable gate array (FPGA), an application specific integrated circuit (ASIC), firmware, etc.), or another suitable processor. The controller 106 can include a processor 110 configured to execute instructions stored in memory. The processor 110 can be a processing device. In operation, the controller 106 can directly read, write, or otherwise program (e.g., erase) regions of memory in the logical units 120, such as by reading from and/or writing to groups of memory cells 122 (e.g., memory pages, stripes of memory pages, memory blocks 128, etc.).

In the illustrated example, the controller 106 includes an embedded memory 132 configured to store various processes, logic flows, and routines for controlling operation of the memory device 100, including managing the logical units 120 and handling communications between the memory device 100 and the host device 108. In some embodiments, the embedded memory 132 can include memory registers storing, for example, memory pointers, fetched data, etc. The embedded memory 132 can also include read-only memory (ROM) for storing micro-code.

The controller 106 communicates with the host device 108 over a system bus 115. In some embodiments, the host device 108 and the controller 106 can communicate over a serial interface, such as a serial attached SCSI (SAS), a serial AT attachment (SATA) interface, a peripheral component interconnect express (PCIe), or other suitable interface (e.g., a parallel interface). The host device 108 can send various requests (in the form of, for example, a packet or stream of packets) to the controller 106. A request can include a command to write, erase, read or return information, and/or to perform a particular operation (e.g., a TRIM operation). In some embodiments, the host device 108 can send various vendor specific (VS) commands to perform one or more restricted operations (e.g., access a restricted region of the logical units 120, enter a debugging mode, reset restricted data, etc.).

As shown, the controller 106 communicates with the logical units 120 via the I/O expander 104. More specifically, a front-end channel 117 (e.g., a single front-end channel, only one front-end channel, one of a plurality of front-end channels) operably couples the controller 106 to a front-end (of first) interface of the I/O expander 104, and a plurality of back-end channels 118 (identified individually in FIG. 1 as first back-end channel 118a, second back-end channel 118b, third back-end channel 118c, and fourth back-end channel 118d) operably couple a back-end (or second) interface of the I/O expander 104 to corresponding logical units 120. In the illustrated embodiment, each back-end channel 118 operably couples the I/O expander 104 to a corresponding group of logical units 120. In other embodiments, back-end channels 118 can operably couple the I/O expander 104 to individual logical units 120 (or to individual memory packages 102 including logical units 120).

In some embodiments, the controller 106, the I/O expander 104, and/or the plurality of memory packages 102 communicate with one another in accordance with Open NAND Flash Interface (ONFI) protocols. Thus, the front-end channel 117 and/or the back-end channels 118 can be ONFI channels, and the controller 106 and/or the logical units 120 (or a memory package 102 including the logical units 120) may include ONFI communication interfaces. In other embodiments, the controller 106, the I/O expander 104, and/or the plurality of logical units 120 can communicate in accordance with other communication protocols.

As shown in FIG. 1, the I/O expander 104 and the logical units 120 are arranged in a memory package 102. Thus, in the illustrated embodiment, the I/O expander 104 can be positioned on (or incorporated into) a package substrate on which the logical units 120 (e.g., memory dies) may also be positioned. In these and other embodiments, all or a portion of the I/O expander 104 can be positioned at other locations within the memory device 100. For example, all or a portion of the I/O expander 104 can be positioned between the controller 106 and the plurality of logical units 120, such as on a printed circuit board (PCB) or other substrate (not shown) on which the controller 106 and/or the logical units 120 may also be positioned. Continuing with this example, the logical units 120 can be individual memory packages 102, or the logical units 120 can be arranged in a memory package 102 that does not include the I/O expander 104. In these and other embodiments, all or a portion of the I/O expander 104 can be incorporated into the controller 106.

In operation, the I/O expander 104 is configured to selectively couple the front-end channel 117 to one or more of the back-end channels 118 to facilitate transmitting communications between (a) the controller 106 and (b) one or more of the logical units 120 or one or more groups of the logical units 120. For example, the I/O expander 104 can selectively couple (e.g., via a first set of switches internal the I/O expander 104) the front-end channel 117 to the first back-end channel 118a to enable communication between the controller 106 and one or more of the logical units 120 coupled to the first back-end channel 118a. As another example, the I/O expander 104 can selectively couple (e.g., via a second set of switches internal the I/O expander 104) the front-end channel 117 to all of the back-end channels 118 to enable communication between the controller 106 and one or more of the logical units 120 coupled to any of the back-end channels 118. As still another example, the I/O expander 104 can selectively couple (e.g., via a third set of switches internal the I/O expander 104) the front-end channel 117 to any subset of the back-end channels 118, such as to the second back-end channel 118b and the third back-end channel 118c.

In some embodiments, the I/O expander 104 can be controlled by the controller 106. For example, when the controller 106 operates to transmit a communication to one or more of the logical units 120 coupled to the first back-end channel 118a, the controller 106 can instruct (e.g., using one or more chip select signals CE # or one or more volume select signals) the I/O expander 104 to couple the front-end channel 117 to the first back-end channel 118a. In response to the instructions received from the controller 106, the I/O expander 104 can couple the front-end channel 117 to the first back-end channel 118a. The controller 106 can then transmit the communication to the I/O expander 104 via the front-end channel 117, and the I/O expander 104 can route (e.g., forward, relay, pass, feed, transmit, redrive) the communication to the one or more logical units 120 via the first back-end channel 118a.

As another example, when a logical unit 120 coupled to the second back-end channel 118b operates to transmit a communication to the controller 106, the controller 106 can instruct the I/O expander 104 to couple the front-end channel 117 to the second back-end channel 118b. In response to the instructions received from the controller 106, the I/O expander 104 can couple the front-end channel 117 to the second back-end channel 118b. The logical unit 120 can then transmit the communication to the I/O expander 104 via the second back-end channel 118b, and the I/O expander 104 can route (e.g., forward, relay, pass, feed, transmit, redrive) the communication to the controller 106 via the front-end channel 117.

In these and other embodiments, the I/O expander 104 can manage connections between the front-end channel 117 and the back-end channels 118. For example, the I/O expander 104 can receive a communication from the controller 106 via the front-end channel 117. The communication can include an indication of the logical units 120 for which the communication is intended. In response, the I/O expander 104 can (a) couple the front-end channel 117 to corresponding back-end channels 118 and/or (b) route (e.g., forward, relay, pass, feed, transmit, redrive) the communication to the logical units 120 via the corresponding back-end channels 118. As another example, the I/O expander 104 can receive a communication from a logical unit 120 via one of the back-end channels 118. The communication may include an indication that the communication is intended for the controller 106. In response to receiving the communication and/or in response to the indication, the I/O expander 104 can (a) couple the front-end channel 117 to the one of the back-end channels 118 and/or (b) route (e.g., forward, relay, pass, feed, transmit, redrive) the communication to the controller 106 via the front-end channel 117.

Additionally, or alternatively, the I/O expander 104 can be controlled by one or more of the logical units 120 (or by a memory package 102 that includes the logical units 120 and/or the I/O expander 104). For example, when a logical unit 120 operably coupled to the second back-end channel 118b operates to transmit a communication to the controller 106, the logical unit 120 (or a memory package 102 including the logical unit 120) can instruct the I/O expander 104 to couple the second back-end channel 118b to the front-end channel 117. In response to the instructions received from the logical unit 120 (or from the memory package 102 including the logical unit 120), the I/O expander 104 can couple the front-end channel 117 to the second back-end channel 118b. The logical unit 120 can then transmit the communication to the I/O expander 104 via the second back-end channel 118b, and the I/O expander 104 can route (e.g., forward, relay, pass, feed, transmit, redrive) the communication to the controller 106 via the front-end channel 117.

As another example, when the controller 106 operates to transmit a communication to one or more logical units 120 coupled to the first back-end channel 118a, the one or more logical units 120 (or a memory package 102 including the one or more logical units 120) can instruct the I/O expander 104 to couple the first back-end channel 118a to the front-end channel 117. In response to the instructions received from the one or more logical units 120 (or from the memory package 102 including the one or more logical units 120), the I/O expander 104 can couple the first back-end channel 118a to the front-end channel 117. The controller 106 can then transmit the communication to the I/O expander 104 via the front-end channel 117, and the I/O expander 104 can route (e.g., forward, relay, pass, feed, transmit, redrive) the communication to the one or more logical units 120 via the first back-end channel 118a.

Although shown with a single I/O expander 104 in FIG. 1, the memory device 100 can include more than one I/O expander 104 in other embodiments. For example, the memory device 100 may include (a) multiple memory packages 102 and (b) one or more corresponding I/O expanders 104 dedicated to and/or incorporated into all or a subset of the memory packages 102. As another example, the memory device 100 can include multiple instances of the front-end channel 117, the I/O expander 104, the back-end channels 118, and/or the logical units 120 shown in FIG. 1. Additionally, or alternatively, an I/O expander 104 may be operably coupled to more than one front-end channel 117 and/or may be operably coupled to a greater or lesser number of back-end channels 118 than shown in FIG. 1. In these and other embodiments, the number of front-end channels 117 and/or the number of back-end channels 118 coupled to different I/O expanders 104 of the memory device 100 can be uniform or vary across the different I/O expanders 104. In these and still other embodiments, the memory device 100 may include a greater or lesser number of logical units 120 than shown in FIG. 1, and/or a greater or lesser number of logical units 120 coupled to each back-end channel 118 than shown in FIG. 1. In some embodiments, the number of logical units 120 coupled to different back-end channels 118 can be uniform or vary across the same or different I/O expanders 104 of the memory device 100.

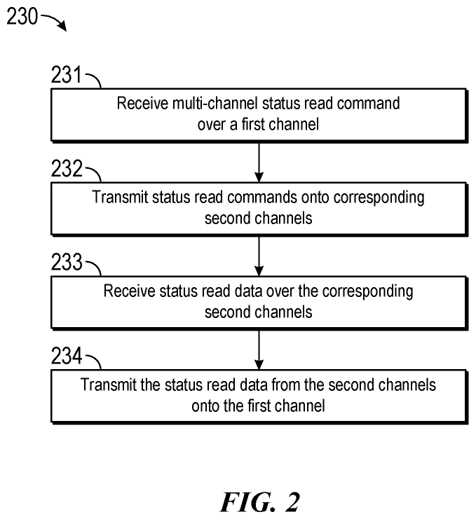

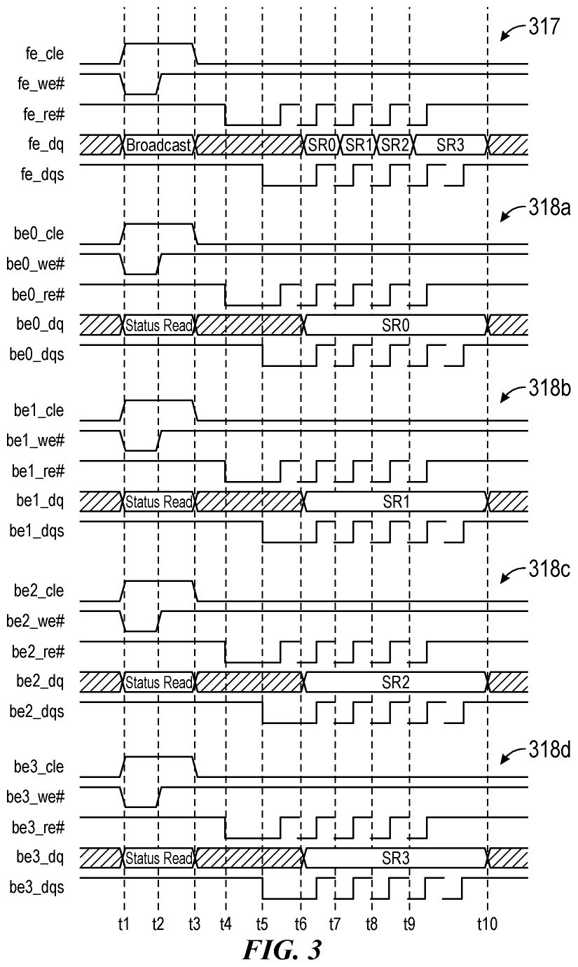

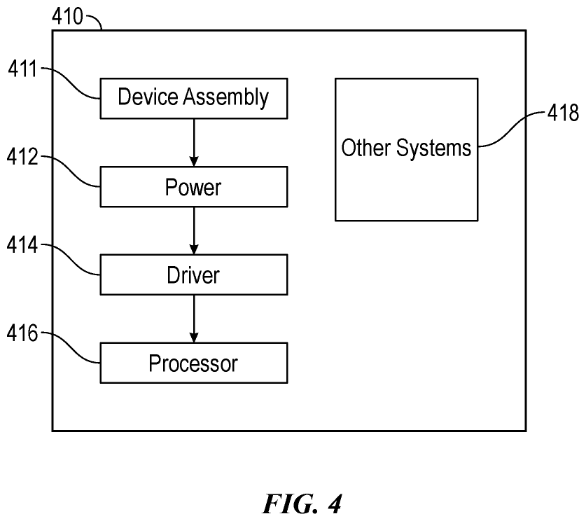

FIG. 2 is a flow diagram illustrating a method 230 of operating a memory device in accordance with various embodiments of the present technology. The method 230 is illustrated as a set of steps or blocks 231-234. Any one or more of the steps of blocks 231-234 can be performed by components of a memory system, such as a host device, a memory device, a controller, an I/O expander, and/or one or more logical units. For the sake of clarity and example, the blocks 231-234 are discussed in detail below with reference to the memory system 101 of FIG. 1. Any one or more of the blocks of the method 230 can be executed in accordance with the discussion above and/or in accordance with the discussion of FIGS. 3 and 4 below.

At block 231, the method 230 begins by receiving a multi-channel status read command over a first channel or bus. In some embodiments, the first channel can be a front-end channel. For example, the host device 108 (FIG. 1) or the controller 106 (FIG. 1) can issue a multi-channel status read command, and the controller 106 can transmit the multi-channel status read command to the I/O expander 104 (FIG. 1) via the front-end channel 117 (FIG. 1). In this example, the front-end channel 117 can be the first channel.

In some embodiments, the multi-channel status read command can be a single (e.g., only one) command. For example, the multi-channel status read command can include a single, command ID (e.g., a single, reserved and/or NAND command ID) that the I/O expander 104 can interpret as instructions to transmit status read commands to logical units 120 over two or more of the back-end channels 118 (FIG. 1). The two or more back-end channels 118 can include all or a subset of the back-end channels 118a-118d. For example, different reserved command IDs can be used to identify different combinations of back-end channels 118a-118d onto which the I/O expander 104 is to output status read commands. Continuing with this example, the controller 106 can transmit a reserved command ID to the I/O expander 104 that corresponds to a desired combination of the back-end channels 118a-118d over which to transmit status read commands.

In other embodiments, the multi-channel status read command can be a series of commands. For example, the multi-channel status read command can include a series of command IDs (e.g., a series of reserved and/or NAND command IDs). Each command ID can identify one or more of the back-end channels 118 onto which the I/O expander 104 is to output a status read command. Additionally, or alternatively, each command ID of the series can be received at block 231 in parallel or in series according to a specified cadence or timing.

In these and other embodiments, receiving the multi-channel status read command can include receiving an address. For example, a multi-channel status read command can be activated upon receipt of an address at block 231. The address can be an address of one or more logical units 120 coupled to the I/O expander 104 via the second channels. In some embodiments, receiving the multi-channel status read command can then include, after receiving the address, receiving a sequence/series of one or more command IDS (e.g., one or more reserved and/or NAND command IDs), as discussed above. Alternatively, receiving the multi-channel status read command can include receiving the address without subsequently receiving a sequence/series of one or more command IDs.

At block 232, the method 230 continues by transmitting status read commands over two or more second channels or buses. The second channels can correspond to the first channel. Additionally, or alternatively, the second channels can include back-end channels. For example, the second channels can include two or more of the back-end channels 118 of FIG. 1.

In some embodiments, transmitting the status read commands can include transmitting the status read commands over the second channels in response to the multi-channel status read command received at block 231. In these and other embodiments, the multi-channel status read command received at block 231 can identify the second channels. In these embodiments, transmitting the status read commands at block 232 can include transmitting a status read command onto each of the second channels identified in the multi-channel status read command. For example, the multi-channel status read command can be interpreted as a command to transmit a status read command to logical units 120 over two or more (e.g., all or a subset) of the back-end channels 118 such that transmitting the status read commands at block 232 can include transmitting a status read command over all or less than all of the back-end channels 118 in response to receiving a multi-channel status read command at block 231.

In some embodiments, transmitting the status read commands can include routing (e.g., forwarding, relaying, passing, feeding, transmitting, redriving) all or a portion of the multi-channel status read command received at block 231 onto the second channels. For example, the multi-channel status read command can include a status read command that can be routed (e.g., fed, relayed, passed, redriven) onto the second channels. In these and other embodiments, transmitting the status read commands can include translating or interpreting the multi-channel status read command received at block 231, and issuing or transmitting status read commands onto the second channels. In some embodiments, transmitting the status read commands includes transmitting the status read commands over the second channels in parallel. In other embodiments, transmitting the status read commands includes individually or separately transmitting the status read commands over the second channels (e.g., at different times, such as in sequence). In these and still other embodiments, transmitting the status read commands can include coupling the first channel to the second channels.

In some embodiments, transmitting a status read command over one of the second channels can include transmitting the status read command to all logical units 120 coupled to the one of the second channels. In these and other embodiments, transmitting the status read command over the one of the second channels can include transmitting the status read command to a subset of the logical units 120 (e.g., only active or enabled logical units 120) coupled to the one of the second channels.

At block 233, the method 230 continues by receiving status read data over the second channels. For example, when logical units 120 receive the status read commands transmitted over the second channels at block 232, the logical units 120 can, in response, perform status read operations and output corresponding status read data. The logical units 120 can output (e.g., return, drive) the status read data onto the second channels. For example, logical units 120 can output status read data to the I/O expander 104 via a same back-end channel 118 over which the logical units 120 received a status read command that was transmitted at block 232. Thus, the status read data can be received at block 233 from multiple logical units 120 over the same second channels used to transmit the status read commands to the multiple logical units 120 at block 232. Logical units 120 that output status read data in response to the status read commands transmitted at block 232 can include all logical units 120 coupled to the second channels used to transmit the status read commands at block 232. Alternatively, logical units 120 that output status read data in response to the status read commands transmitted at block 232 can include a subset of the logical units 120 (e.g., only active or enabled ones of the logical units 120) coupled to the second channels used to transmit the status read commands at block 232.

In some embodiments, receiving the status read data can include asserting or toggling read enable signals re # (e.g., to all or a subset of the logical units 120) on the second channels that were used to transmit the status read commands at block 232. The read enable signals re # can be used to instruct the logical units 120 when to output status read data onto corresponding ones of the second channels. In some embodiments, asserting or toggling the read enable signals re # can include asserting or toggling the read enable signals re # on different ones of the second channels at the same time such that status read data is received from the logical units 120 over the different ones of the second channels in parallel at block 233. In these and other embodiments, asserting or toggling the read enable signals re # can include asserting or toggling the read enable signals re # over different ones of the second channels at different times such that status read data is received from the logical units 120 over the different ones of the second channels at different times (e.g., in sequence) at block 233. Various read enable signals re # of the present technology are discussed in greater detail below with reference to FIG. 3.

In these and other embodiments, receiving the status read data can include receiving one or more communication strobe signals dqs on the second channels. The communication strobe signal(s) dqs can be used to indicate an appropriate timing or cadence to read (e.g., latch) status read data output by the logical units 120. In some embodiments, a communication strobe signal dqs can be a delayed version of a corresponding one of the read enable signals re # transmitted to logical units 120 over a corresponding one of the second channels. In these and other embodiments, a communication strobe signal dqs can be received over all or a subset of the second channels used at block 232 to transmit status read commands to logical units 120.

At block 234, the method 230 continues by transmitting the status read data received at block 233 onto the first channel. In some embodiments, transmitting the status read data can include sequentially transmitting the status read data by cycling through individual ones of the second channels and transmitting corresponding status read data onto the first channel. Transmitting status read data onto or over the first channel can include routing (e.g., forwarding, relaying, passing, feeding, transmitting, redriving) the status read data received via a corresponding one of the second channels to the first channel.

As a specific example, the I/O expander 104 can, at block 233, receive (a) first status read data over the first back-end channel 118a and (b) second status read data over the second back-end channel 118b. At block 234, the I/O expander 104 can cycle through the first and second back-end channels 118a and 118b to transmit the first and second status read data, respectively, to the controller 106 via the front-end channel 117. More specifically, the I/O expander 104 can couple the front-end channel 117 to the first back-end channel 118a, and can transmit the first status read data to the controller 106 by driving the front-end channel 117 from the first back-end channel 118a. Then, the I/O expander 104 can couple the front-end channel 117 to the second back-end channel 118a, and can transmit the second status read data to the controller 106 by driving the front-end channel 117 from the second back-end channel 118b. Continuing with this example, the I/O expander 104 can receive the second status read data while transmitting the first status read data to the controller 106 via the front-end channel 117, and/or the I/O expander 104 can receive the first status read data while transmitting the second status read data to the controller 106 via the front-end channel 117. Alternatively, the I/O expander 104 can receive the second status read data after the I/O expander 104 has transmitted the first status read data to the controller 106 via the front-end channel 117. Additionally, or alternatively, the I/O expander 104 can stop receiving the first status read data after the I/O expander 104 has transmitted the first status read data to the controller 106, or the I/O expander 104 can stop receiving the first status read data when the I/O expander 104 begins transmitting the second status read data to the controller 106 via the front-end channel 117.

In some embodiments, transmitting the status read data over the first channel can include transmitting the status read data over the first channel according to a timing or cadence indicated by a read enable signal re # received at block 234. For example, the controller 106 can assert or toggle a read enable signal re # on the front-end channel 117 to instruct the I/O expander 104 to transmit status read data to the controller 106 via the front-end channel 117. The read enable signal re # can define or dictate timing windows in which the I/O expander 104 can transmit the status read data to the controller 106 over the front-end channel 117. In some embodiments, the I/O expander 104 can cycle through each of the second channels and transmit corresponding status read data to the controller 106 within one or more of the windows defined by the read enable signal re #. For example, the I/O expander 104 can transmit first status read data from a first one of the second channels to the controller 106 during a first timing window defined by the read enable signal re #, and can transmit second status read data from a second one of the second channels to the controller 106 during a second timing window defined by the read enable signal re #. Various read enable signals re # of the present technology are discussed in greater detail below with reference to FIG. 3.

In these and other embodiments, transmitting the status read data over the first channel can include cycling through the second channels according to a timing or cadence indicated by the one or more communication strobe signals dqs received from the logical units 120 at block 233. For example, the I/O expander 104 can, on an edge or cycle (e.g., on each edge or each cycle) of a communication strobe signal dqs, switch from (a) transmitting status read data onto the first channels from one of the second channels to (b) transmitting status read data onto the first channel from another of the second channels. In some embodiments, when the I/O expander 104 receives status read data via one of the second channels and transmits the status read data onto the first channel, the I/O expander 104 can use a communication strobe signal dqs received via that one of the second channels to determine a timing or cadence to switch to another one of the second channels to transmit status read data received via the other one of the second channels onto the first channel. In other embodiments, when the I/O expander 104 receives status read data via one of the second channels and transmits the status read data onto the first channel, the I/O expander 104 can use a communication strobe signal dqs received via another one of the second channels to determine a timing or cadence to switch to the other one of the second channels to begin transmitting status read data received via the other one of the second channels onto the first channel. In still other embodiments, the I/O expander 104 can use a communication strobe signal dqs received via one of the second channels to determine a timing or cadence to cycle through the second channels and transmit corresponding status read data onto the first channel, regardless of (e.g., independent of) whether that one of the second channels is currently being used to transmit status read data to the I/O expander 104 and/or whether the I/O expander 104 is currently transmitting status read data received via that one of the second channels onto the first channel. In some embodiments, that one of the second channels is the only second channel used to transmit a communication strobe signal dqs to the I/O expander 104. In these and other embodiments, the I/O expander 104 uses only the communication strobe signal dqs received from that one of the second channels to determine a timing or cadence to cycle through the second channels.

Although the blocks 231-234 of the method 230 are discussed and illustrated in a particular order, the method 230 illustrated in FIG. 2 is not so limited. In other embodiments, the method 230 can be performed in a different order. In these and other embodiments, any of the blocks 231-234 of the method 230 can be performed before, during, and/or after any of the other blocks 231-234 of the method 230. For example, all or a portion of the block 234 can be performed while executing all or a portion of the block 233. Moreover, a person of ordinary skill in the relevant art will recognize that the illustrated method 230 can be altered and still remain within these and other embodiments of the present technology. For example, one or more blocks 231-234 of the method 230 illustrated in FIG. 2 can be omitted and/or repeated in some embodiments. As another example, the method 230 can iteratively cycle through blocks 233 and 234 in some embodiments. In particular, the method 230 can receive first status read data over the first back-end channel 118a (e.g., by toggling a read enable signal re # on the first back-end channel 118a at a first time) at block 233, transmit the first status read data to the controller 106 via the front-end channel 117 at block 234, return to block 233 and receive second status read data over the second back-end channel 118b (e.g., by toggling a read enable signal re # on the second back-end channel 118b at a second time that is the same or different from the first time), and transmit the second status read data to the controller 106 via the front-end channel 117 at block 234.

FIG. 3 illustrates signal diagrams 317 and 318a-318d corresponding to a specific example of the method 230 of FIG. 2. The signal diagram 317 of FIG. 3 illustrates example timings of signals transmitted over the front-end channel 117 of FIG. 1. In addition, the signal diagrams 318a-318d illustrate example timings of signals transmitted over the back-end channels 118a-118d, respectively, of FIG. 1.

As shown in the signal diagram 317 of FIG. 3, the controller 106 transmits a multi-channel status read command ‘Broadcast’ to the I/O expander 104 between time t1 and time t3. In particular, the controller 106 transmits the multi-channel status read command ‘Broadcast’ in a communication signal fe_dq over the front-end channel 117 (FIG. 1). In addition, the controller 106 (a) asserts a command latch enable signal fe_cle from time t1 to time t3 to alert the I/O expander 104 that the controller 106 is transmitting a command to the I/O expander 104 via the front-end channel 117, and (b) toggles a write enable signal fe_we # at time t1 and time t2 to clock the multi-channel status read command ‘Broadcast’ into the I/O expander 104 via the front-end channel 117.

In the illustrated embodiment, the multi-channel status read command ‘Broadcast’ is a command to transmit or broadcast status read commands to logical units 120 over all of the back-end channels 118a-118d. Thus, as shown in the signal diagrams 318a-318d between time t1 and time t3, the I/O expander 104 transmits status read commands ‘Status Read’ to logical units 120 over each of the back-end channels 118a-118d in response to receiving the multi-channel status read command ‘Broadcast.’ In particular, referring to the signal diagram 318a, the I/O expander 104 (a) transmits a status read command ‘Status Read’ in a communication signal be0_dq to logical units 120 (e.g., active or enabled logical units 120) coupled to the first back-end channel 118a, (b) asserts a command latch enable signal be0_cle from time t1 to time t3 to alert the corresponding logical units 120 that the I/O expander 104 is transmitting a command to the logical units 120 via the first back-end channel 118a, and (c) toggles a write enable signal be0_we # at time t1 and time t2 to clock the status read command ‘Status Read’ into the logical units 120 via the first back-end channel 118a.

At the same time, referring to the signal diagrams 318b-318d, the I/O expander 104 (a) transmits status read commands ‘Status Read’ in communication signals be1_dq-be3_dq to other logical units 120 (e.g., other active or enabled logical units 120) over each of the other back-end channels 118b-118d, (b) asserts command latch enable signals be1_cle-be3_cle from time t1 to time t3 to alert the corresponding logical units 120 that the I/O expander 104 is transmitting commands to the logical units 120 via the back-end channels 118b-118d, and (c) toggles write enable signals be1_we #-be3_we # at time t1 and time t2 to clock the status read commands ‘Status Read’ into the logical units 120 via the back-end channels 118b-118d.

In some embodiments, the I/O expander 104 receives the multi-channel status read command ‘Broadcast’; interprets the multi-channel status read command ‘Broadcast’ as a command to transmit a status read command ‘Status Read’ to logical units 120 over all of the back-end channels 118; and transmits (e.g., drives, issues, sends) a status read command ‘Status Read’ to the logical units 120 over all of the back-end channels 118. In these and other embodiments, the multi-channel status read command ‘Broadcast’ can include (a) a status read command ‘Status Read’ and/or (b) an indication to signal the I/O expander to transmit the status read command ‘Status Read’ to logical units 120 over all of the back-end channels 118a-118d. In response, the I/O expander can transmit (e.g., pass, feed, forward, route, relay, redrive) the status read command ‘Status Read’ from the front-end channel 117 to each of the back-end channels 118a-118d.

At time t4, the controller 106 begins to toggle a read enable signal fe_re # on the front-end channel 117, as shown in the signal diagram 317. More specifically, the controller 106 toggles the read enable signal fe_re # low from time t4 to time t5 and then begins to repeatedly toggle the read enable signal fe_re # between time t5 and time t10. The read enable signal fe_re # can be used to instruct the I/O expander 104 to begin outputting communications (e.g., data or other information) to the controller 106 via the front-end channel 117. In some embodiments, the front-end channel 117 can be a half-duplex bus, meaning that either the write enable signal fe_we # or the read enable signal fe_re # can be toggling at a given time, but not both.

Similarly, at time t4, the I/O expander 104 begins to toggle read enable signals be0_re #-be3_re # on the back-end channels 118 (e.g., in response to the controller 106 toggling the read enable signal fe_re # on the front-end channel 117), as shown in the signal diagrams 318a-318d. In particular, the I/O expander 104 toggles the read enable signals be0_re #-be3_re # low from time t4 to time t5, and then begins to repeatedly toggle the read enable signal be0_re #-be3_re # between time t5 and time t10. The read enable signals be0_re #-be3_re # can be used to instruct the logical units 120 to begin outputting communications (e.g., data or other information, such as status read data) to the I/O expander 104 over corresponding back-end channels 118. In some embodiments, the back-end channels 118 can each be a half-duplex bus, meaning that either the corresponding write enable signal be0_we #-be3_we # or the corresponding read enable signal be0_re #-be3_re # can be toggling at a time, but not both.

At time t5, the I/O expander 104 begins toggling a communication strobe signal fe_dqs on the front-end channel 117, and the logical units 120 begin toggling communication strobe signals be0_dqs-be3_dqs on the back-end channels 118a-118d. The communication strobe signal fe_dqs can be a delayed version of the read enable signal fe_re #, and can be transmitted over the front-end channel 117 for the controller 106 to determine proper times at which to latch information (e.g., status read data) in the communication signal fe_dq received from the I/O expander 104. Similarly, the communication strobe signals be0_dqs-be3_dqs can be delayed versions of corresponding ones of the read enable signals be0_re #-be3_re #, and can be transmitted over corresponding ones of the back-end channels 118 for the I/O expander 104 to determine proper times at which to latch information (e.g., status read data) in the communication signals be0_dq-be3_dq received from the logical units 120.

As shown in the signal diagrams 318a-318d, the logical units 120 (e.g., active or enabled logical units 120) can perform status read operations in response to the status read commands ‘Status Read’ such that the logical units 120 output status read data SR0-SR3 to the I/O expander 104 starting at time t6. The timing of when the status read data SR0-SR3 is output from the logical units 120 can depend on the toggling of the corresponding read enable signal be0_re #-be3_re #. In the illustrated embodiment, the logical units 120 repeatedly or continuously transmit status read data SR0-SR3 to the I/O expander 104 from time t6 to time t10. Although the I/O expander 104 continuously receives the status read data SR0-SR3 over the back-end channels 118 from time t6 to time t10, the I/O expander 104 can ignore status read data received over a back-end channel at times outside of when the I/O expander 104 is transmitting the status read data on that back-end channel to the controller 106, as discussed in greater detail below.

In other embodiments, the logical units 120 can transmit status read data SR0-SR3 to the I/O expander 104 over a corresponding back-end channel 118 for only a portion of the time between time t6 and time t10. For example, logical units 120 coupled to the first back-end channel 118a can transmit first status read data SR0 to the I/O expander 104 from time t6 to time t7 (e.g., the logical units 120 can start transmitting the first status read data SR0 at time t6 and/or can stop transmitting the first status read data SR0 at time t7). Continuing with this example, logical units 120 coupled to the second back-end channel 118b can transmit second status read data SR1 to the I/O expander 104 from time t7 to time t8 (e.g., the logical units 120 can start transmitting the second status read data SR1 at time t7 and/or can stop transmitting the second status read data SR1 at time t8). Additionally, or alternatively, logical units 120 coupled to the third back-end channel 118c can transmit third status read data SR2 to the I/O expander 104 from time t8 to time t9 (e.g., the logical units 120 can start transmitting the third status read data SR2 at time t8 and/or can stop transmitting the third status read data SR2 at time t9). Logical units 120 coupled to the fourth back-end channel 118d can transmit fourth status read data SR3 to the I/O expander 104 from time t9 to time t10 (e.g., the logical units 120 can start transmitting the fourth status read data SR3 at time t9 and/or can stop transmitting the fourth status read data SR3 at time t10).

As the logical units 120 transmit the status read data SR0-SR3 to the I/O expander 104, the I/O expander 104 can (e.g., automatically) cycle through the back-end channels 118a-118d and individually transmit the status read data SR0-SR3 to the controller 106 via the front-end channel 117. For example, as shown in the signal diagram 317, the I/O expander 104 can transmit the first status read data SR0 to the controller 106 from time t6 to time t7. In particular, the I/O expander 104 can (a) couple the first back-end channel 118a to the front-end channel 117 and/or (b) transmit (e.g., forward, relay, pass, feed, route, redrive) the first status read data SR0 to the controller 106 via the front-end channel 117. As a specific example, the I/O expander 104 can couple the front-end channel 117 to the first back-end channel 118a such that the logical units 120 coupled to the first back-end channel 118a can, from time t6 to time t7, drive the first status read data SR0 to the controller 106 via the first back-end channel 118a, the I/O expander 104, and the front-end channel 117.

After transmitting the first status read data SR0 to the controller 106, the I/O expander 104 can cycle to the second back-end channel 118b to transmit the second status read data SR1 to the controller 106 from time t7 to time t8. In particular, the I/O expander 104 can (a) uncouple the first back-end channel 118a from the front-end channel 117, (b) couple the second back-end channel 118b to the front-end channel 117, and/or (c) transmit (e.g., forward, relay, pass, feed, route, redrive) the second status read data SR1 to the controller 106 via the front-end channel 117. As a specific example, the I/O expander 104 can couple the front-end channel 117 to the second back-end channel 118b such that the logical units 120 coupled to the second back-end channel 118b can, from time t7 to time t8, drive the second status read data SR1 to the controller 106 via the second back-end channel 118b, the I/O expander 104, and the front-end channel 117.

After transmitting the second status read data SR1 to the controller 106, the I/O expander 104 can similarly (a) transmit the third status read data SR2 to the controller 106 via the front-end channel 117 from time t8 to time t9, and (b) transmit the fourth status read data SR3 to the controller 106 via the front-end channel 117 from time t9 to time t10. In some embodiments, transmission of the fourth status read data SR3 to the controller 106 can occur over a larger timing window than transmission of the other status read data SR0-SR2 as part of an established communication protocol.

In this manner, memory devices incorporating I/O expanders configured in accordance with various embodiments of the present technology can (a) issue a single multi-channel status read command, and (b) obtain status read data from logical units coupled to two or more channels (e.g., two or more back-end channels). The status read data can be obtained over the two or more back-end channels without individually signaling or instructing the I/O expanders to couple the front-end channel to each of the back-end channels at different times, and/or without individual transmitting status read commands from the controller to logical units over each of the two or more back-end channels at different times. Rather, the I/O expanders can be configured to transmit status read commands to logical units over each of the two or more back-end channels in response to a single multi-channel status read command, and to (e.g., automatically) cycle through the two or more back-end channels to return corresponding status read data to the controller. Thus, in accordance with the discussion above, the present technology is expected to reduce overhead on the I/O channels between the controller and the logical units.

FIG. 4 is a schematic view of a system that includes a memory device in accordance with various embodiments of the present technology. Any one of the foregoing memory devices described above with reference to FIGS. 1-3 can be incorporated into any of a myriad of larger and/or more complex systems, a representative example of which is system 410 shown schematically in FIG. 4. The system 410 can include a semiconductor device assembly 411, a power source 412, a driver 414, a processor 416, and/or other subsystems and components 418. The semiconductor device assembly 411 can include features generally similar to those of the memory devices described above with reference to FIGS. 1-3, and can, therefore, include memory devices with I/O expanders and multi-channel status reads. The resulting system 410 can perform any of a wide variety of functions, such as memory storage, data processing, and/or other suitable functions. Accordingly, representative systems 410 can include, without limitation, hand-held devices (e.g., mobile phones, tablets, digital readers, and digital audio players), computers, vehicles, appliances, and other products. Components of the system 410 may be housed in a single unit or distributed over multiple, interconnected units (e.g., through a communications network). The components of the system 410 can also include remote devices and any of a wide variety of computer-readable media.

### C. CONCLUSION

As used herein, the terms “memory system” and “memory device” refer to systems and devices configured to temporarily and/or permanently store information related to various electronic devices. Accordingly, the term “memory device” can refer to a single memory die, to a memory package containing one or more memory dies, to a memory package operably coupled to a memory controller, and/or to a plurality of memory packages operably coupled to a memory controller. Similarly, the term “memory system” can refer to a system including one or more memory dies (e.g., a memory package); to a memory package operably coupled to a memory controller; to a plurality of memory packages operably coupled to a memory controller (e.g., to a dual in-line memory module (DIMM), such as a non-volatile DIMM (NVDIMM)); and/or to a system including one or more memory packages, a memory controller, and/or a host device.

From the foregoing, it will be appreciated that specific embodiments of the technology have been described herein for purposes of illustration, but well-known structures and functions have not been shown or described in detail to avoid unnecessarily obscuring the description of the embodiments of the technology. Where the context permits, singular or plural terms can also include the plural or singular term, respectively. Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. As used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same feature(s) and/or additional types of other features are not precluded. Moreover, the terms “connect” and “couple” are used interchangeably herein and refer to both direct and indirect connections or couplings. For example, where the context permits, element A “connected” or “coupled” to element B can refer (i) to A directly “connected” or directly “coupled” to B and/or (ii) to A indirectly “connected” or indirectly “coupled” to B.

The above detailed descriptions of embodiments of the technology are not intended to be exhaustive or to limit the technology to the precise form disclosed above. Although specific embodiments of, and examples for, the technology are described above for illustrative purposes, various equivalent modifications are possible within the scope of the technology, as those skilled in the relevant art will recognize. For example, while steps are presented in a given order, alternative embodiments can perform steps in a different order. As another example, various components of the technology can be further divided into subcomponents, and/or various components and/or functions of the technology can be combined and/or integrated. Furthermore, although advantages associated with certain embodiments of the technology have been described in the context of those embodiments, other embodiments can also exhibit such advantages, and not all embodiments need necessarily exhibit such advantages to fall within the scope of the present technology.

It should also be noted that other embodiments in addition to those disclosed herein are within the scope of the present technology. For example, embodiments of the present technology can have different configurations, components, and/or procedures in addition to those shown or described herein. Moreover, a person of ordinary skill in the art will understand that these and other embodiments can be without several of the configurations, components, and/or procedures shown or described herein without deviating from the present technology. Accordingly, the disclosure and associated technology can encompass other embodiments not expressly shown or described herein.

What is claimed is:

1. An apparatus, comprising:
a controller;
a plurality of logical units including a first set of logical units and a second set of logical units different from the first set; and
an input/output expander (a) coupled to the controller via a controller-side communication channel, (b) coupled to logical units of the first set via a first memory-side communication channel, and (c) coupled to logical units of the second set via a second memory-side communication channel,
wherein the input/output expander is configured to receive, via the controller-side communication channel, a multi-channel status read command from the controller, and
wherein the input/output expander is further configured, based on receiving the multi-channel status read command, to—
transmit, via the first memory-side communication channel, a first status read command to the logical units of the first set,
transmit, via the second memory-side communication channel, a second status read command to the logical units of the second set,
receive, via the first memory-side communication channel, first status read data from the logical units of the first set,
receive, via the second memory-side communication channel, second status read data from the logical units of the second set,
transmit the first status read data to the controller via the controller-side communication channel, and
transmit the second status read data to the controller via the controller-side communication channel.

2. The apparatus of claim 1, wherein the logical units of the first and second sets include memory dies arranged in a same memory package.

3. The apparatus of claim 1, wherein the first set of logical units includes a first set of memory packages, and the second set of logical units includes a second set of memory packages different from the first set of memory packages.

4. The apparatus of claim 1, wherein the plurality of logical units and the input/output expander are arranged in a memory package.

5. The apparatus of claim 1, wherein:
the plurality of logical units is arranged in one or more memory packages; and
the input/output expander is positioned external the controller and the one or more memory packages.

6. The apparatus of claim 1, wherein the input/output expander is configured to transmit that first status read command and the second status read command in parallel.

7. The apparatus of claim 1, wherein the input/output expander is configured to receive, via the first and second memory-side communication channels, the first and second status read data in parallel.

8. The apparatus of claim 1, wherein:
the apparatus is a solid-state drive; and
the controller is configured to communicate with the input/output expander and/or the plurality of logical units according to Open NAND Flash Interface (ONFI) communication protocols.

9. An input/output expander, comprising:
a front-end interface couplable to a front-end communication channel;
a back-end interface couplable to a first back-end communication channel and a second back-end communication channel,
wherein the input/output expander is configured, based on receiving a multi-channel status read command via the front-end communication channel, to—
transmit a first status read command onto the first back-end communication channel, and
transmit a second status read command onto the second back-end communication channel.

10. The input/output expander of claim 9, wherein the input/output expander is further configured, based on receiving the multi-channel status read command, to:
receive, via the first back-end communication channel, first status read data, and
receive, via the second back-end communication channel, second status read data.

11. The input/output expander of claim 10, wherein the input/output expander is further configured, based on receiving the multi-channel status read command, to transmit the first status read data onto the front-end communication channel and to transmit the second status read data onto the front-end communication channel.

12. A method, comprising:
receiving, via a controller-side communication channel, a multi-channel status read command at a first interface of an input/output expander; and
based on receiving the multi-channel status read command—
transmitting, via a second interface of the input/output expander, a status read command to logical units over each of two or more memory-side channels,
receiving, at the second interface, status read data from the logical units over each memory-side channel of the two or more memory-side channels, and
transmitting, via the first interface, the status read data onto the controller-side communication channel.

13. The method of claim 12, wherein transmitting the status read command onto each of the two or more memory-side channels includes transmitting the status read command onto the two or more memory-side channels in parallel.

14. The method of claim 12, wherein transmitting the status read command onto each of the two or more memory-side channels includes transmitting the status read command onto all memory-side channels coupled to the second interface of the input/output expander.

15. The method of claim 12, wherein:
transmitting the status read command to the logical units includes transmitting the status read command to memory dies or memory packages operably coupled to the two or more memory-side channels; and
receiving the status read data from the logical units include receiving the status read data from the memory dies or the memory packages.

16. The method of claim 12, wherein receiving the status read data includes receiving the status read data from the logical units over each of the two or more memory-side channels in parallel.

17. The method of claim 12, wherein receiving the status read data includes receiving the status read data from the logical units over different ones of the two or more memory-side channels at different times.

18. The method of claim 12, wherein receiving the status read data includes toggling a read enable signal transmitted over each of the two or more memory-side channels.

19. The method of claim 12, wherein transmitting the status read data onto the controller-side communication channel includes (a) cycling through individual memory-side channels of the two or more memory-side channels one at a time and (b) transmitting corresponding status read data onto the controller-side communication channel.

20. The method of claim 19, wherein cycling through the individual memory-side channels one at a time includes (a) operably coupling a first memory-side channel of the two or more memory-side channels to the controller-side communication channel, (b) after transmitting status read data corresponding to the first memory-side channel onto the controller-side communication channel, operably uncoupling the first memory-side channel from the controller-side communication channel, and (c) after uncoupling the first memory-side channel, operably coupling a second memory-side channel of the two or more memory-side channels to the controller-side communication channel.

21. The method of claim 12, wherein transmitting the status read data onto the controller-side communication channel includes driving first status read data from a first memory-side channel of the two or more memory-side channels over the controller-side communication channel.
